(19) United States
(12) Patent Application Publication
(10) Pub. No.: US 2005/0207147 A1
(43) Pub. Date: Sep. 22, 2005

(54) Solar LED light source

(75) Inventor: Sunil K. Sinha, Pleasanton, CA (US)

Correspondence Address: Jaya Nair, Esq., 7478 Stanford Place, Cupertino, CA, 95014, US

(73) Assignee: SUNLIT SYSTEMS, INC.

(21) Appl. No.: 10/802,579

(22) Filed: Mar. 17, 2004

(51) Int. Cl. F21L 13/00

(52) U.S. Cl. 362/183; 362/247; 362/399

(57) ABSTRACT

A lighting device having a plurality of LEDs as a light source is provided. The lighting device includes a solar power source, a rechargeable voltage source, a light reflector to reflect the light from the LEDs. The solar power source provide the necessary power to recharge the voltage source and the voltage source provide the power needed for the light source.

### FIELD OF INVENTION

Invention relates to a lighting device and more particularly to solar lighting device with light emitting diode (LED) as a light source.

### BACKGROUND OF INVENTION

Electrical power is generally taken for granted by most people in the U.S. However there are times when there is no primary source of electrical power is available. For example, when a disaster strikes an area electrical power lines are often down for several days. There are states within the U.S. that face electricity shortages and had to have rolling blackouts. In some remote areas as well as in developing countries electricity is still a luxury. In such situations an alternative source of electrical power in conjunction with efficient use of electricity for lighting is proven to be extremely useful.

One of the low cost alternatives is to use LEDs in place of incandescent or fluorescent bulbs as LEDs have longer life compared to incandescent and fluorescent bulbs. In case of incandescent bulbs, a major portion of the energy is used in the bulb is dissipated as heat resulting in inefficient use of energy. Similarly, fluorescent lights require 110 to 220 volts of current to operate it. Whereas, LEDs require considerably lower amount of power. For example, to provide 50 W of light LEDs require only 2.5 W of electricity. As the power consumption of LEDs are lower it would be advantageous to incorporate LEDs into lighting devices.

However the light from the LEDs are directional therefore the light is focused and localized. Moreover the light is extremely sharp and intense and is not recommended for direct viewing. In most applications the light from LEDs are generally diffused. Diffusion results in big losses and diminishes the resulting intensity of the light thus making it almost useless for most applications.

Therefore it can be seen that it will be useful to have a lighting system that is energy efficient and that produces visible light of high intensity which is not directional.

### SUMMARY OF INVENTION

It is an object of the invention to provide an energy efficient lighting system which produces a non-directional visible light of high intensity.

Accordingly, the present invention provides a lighting device comprising a solar power source that is connected to a rechargeable voltage source such that the voltage source is charged using solar power. The voltage source in turn provides the energy to a light source comprising a plurality of LEDs. The light emerging from the LEDs are reflected by a reflective coating surrounding the LED holders. The reflected light provides useful light that is not only non-directional but is also of high intensity.

Yet another object of the invention is to provide full residential and commercial lighting in case of emergency or for other needs by using a plurality of lighting devices that is connected to a solar panel. The lighting devices include a rechargeable voltage source connected to the solar panel wherein the solar panel recharges the voltage source. The voltage source provides the energy to light a light-source having a plurality of LEDs. The light from the LEDs are reflected to provide a high intensity non-directional light that would illuminate a residential or commercial building.

Yet another object of the invention is to provide a portable light that may be carried by a person. In this embodiment, the invention provides a light source having a plurality of LEDs. The light source is energized by a rechargeable voltage source that is recharged by solar energy. The light from the LEDs are reflected to provide high intensity light that is non-directional.

### BRIEF DESCRIPTION OF DRAWINGS

FIG. 1 illustrates a lighting device as one embodiment of the present invention.

FIG. 2 illustrates a more detailed view of the lighting device revealing the arrangements of the reflectors.

FIG. 3. further illustrates a detailed view of the lighting device revealing the solar panel and the reflectors in relation with the solar panel.

FIG. 4. illustrates the reflector cover that holds the LEDs in place.

FIG. 5. illustrates the LED holder that snaps into the reflector.

FIG. 6. illustrates how the light from the LEDs reflecting at the reflective surfaces to provide diffused non-directional light.

FIG. 7 is a graph illustrating light intensity distribution with reference to distance.

FIG. 8 is a block diagram of the lighting system having several lighting devices.

FIG. 9 is a portable lighting device.

### DETAILED DESCRIPTION OF PREFERRED EMBODIMENT(S)

Disclosed here is a lighting device that is durable and energy efficient. The lighting device utilizes light emitting diodes as light source so that it can provide long life. It has re-chargeable voltage source so that it may be re-used to provide long life.

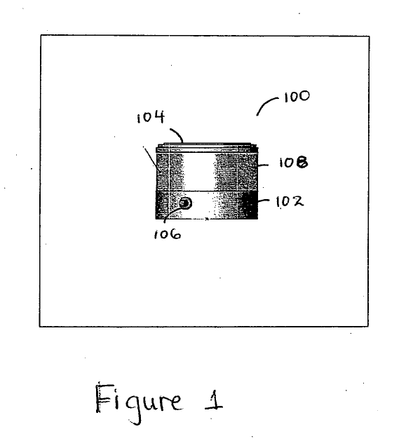

FIG. 1, illustrates a basic structure of a lighting device 100. The lighting device 100 includes a base 102. The lighting device 100 further includes a cover 108. The cover 108 is transparent so that the light may pass through the cover and provide adequate lighting for use. The base is shown to include a switch 106 that controls the current flow to the light source (not shown). The various components (not shown) is protected by the cover 108. The lighting device 100 is further provides with a top piece 104 that holds the solar panel (not shown).

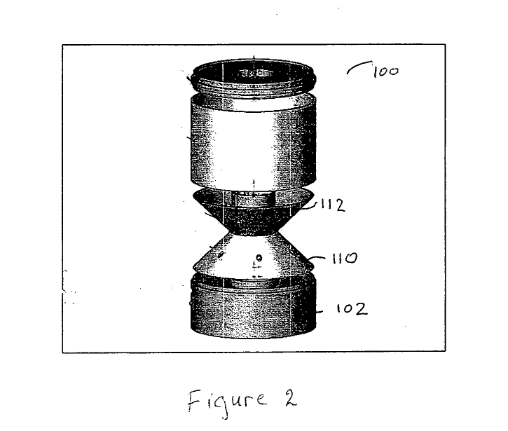

FIG. 2 illustrates the lighting device 100 further revealing the different components that make up the device. This Figure further shows a top reflector 112 and a bottom reflector 110. The reflectors 112 and 110 include a plurality of holes 114 through which the LEDs (not shown) may protrude. The reflectors 110 and 112 are coated with reflective coating so that the light from the LEDs may be reflected to provide diffused lighting. The base 102 may also act as a place to hold the voltage source.

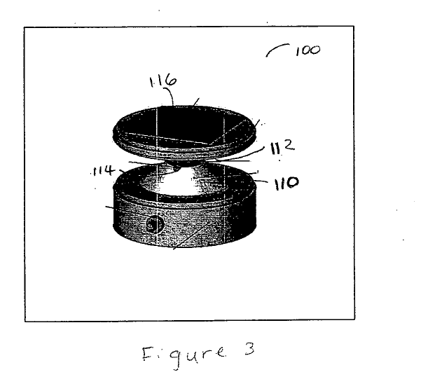

FIG. 3 in view of FIG. 2 illustrate the lighting device 100 further revealing the components that is required for the proper function of the lighting device. In this Figure it can be seen that the wholes for the LEDs 114 in the top and bottom reflectors 110 and 112 are set such that the LED beam of one falls away from another. In FIG. 3, a solar panel 116 is placed on top of the top piece so that a rechargeable voltage source (not shown) may be connected to the solar panel. The voltage source may be recharged using solar energy. The power of the panel depends on the power required by the LED. This may include the number of LEDs in the device. Since the LEDs require small amount of energy, in comparison with conventional light sources, smaller photovoltaic panel can provide sufficient power required by the LEDs.

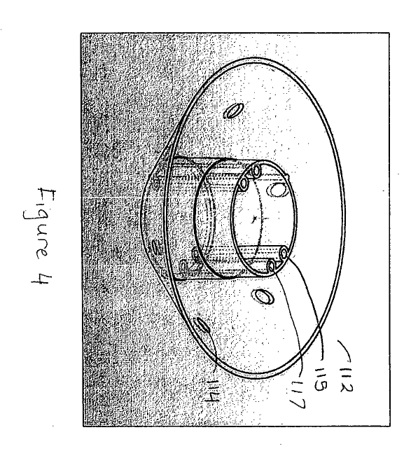

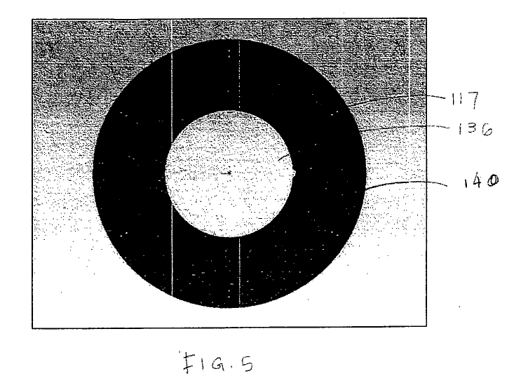

FIG. 4 shows a top view of the top reflector 112. The reflector 112 performs several useful functions in the overall functionality of the lighting device 100. The reflector 112 holds the LED holder (not shown here but shown in detail in FIG. 5). The reflector includes holes 114 through which the LEDs protrude out the reflector so that the light from the LEDs are not obstructed by any means resulting in loss. The reflector 112 is further shown to include a connector 115. The connector 115 helps to snap the LED holder in place in the top reflector 112. The connector 115 has plurality of pipes through which connection from the solar panel to the voltage source may be passed.

The pipes can also carry connections to the LEDs from the voltage source as well as the controller (not shown). The controller performs several functions for the lighting device 100. The controller may be used to control the charging of the voltage source. It may also be used to maintain current and voltage for charging voltage sources. Still yet, the controller may be used to maintain a constant current to the LEDs Even though the description here is shown in terms of the top reflector 112. The bottom reflector 110 also has a similar design to hold LEDs.

The LEDs are held in place by an LED holder 140 as shown in FIG. 5. The LED holder includes LEDs 117. The LED holder 140 may snapped into place and the LEDs protrude through the holes 114 of reflectors 110 and 112 as shown in FIG. 1. The connector 115 shown in FIG. 4 helps to hold the LED holder 140 in place. In this place the LED holder 140 is shown to have a shape of a washer and the connector 115 fit into the circular shape 136 in the middle thus giving it support. The one skilled in the art should appreciate that shapes other than circular may be used as the LED holder. The LED holder 115 shape generally depends on the shape of the reflectors 110 and 112.

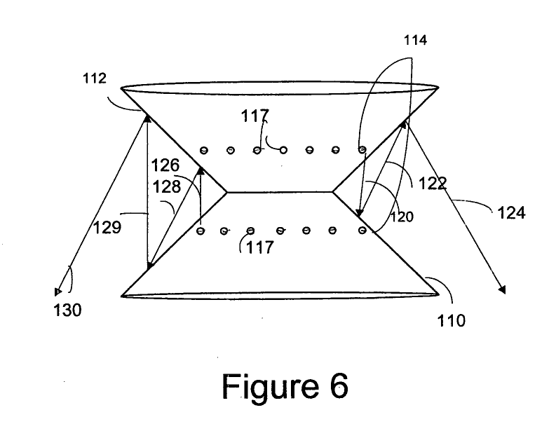

FIG. 6 illustrates how the light from the LEDs are reflected by the reflectors to provides intense diffused light. In this figure the reflectors 110 and 112 are shown. Also shown are the plurality of holes 114 with the LEDs 117 protruding out of the holes. An incident ray 120 from one of the LEDs in the top reflector 112 is reflected after striking the bottom reflector 110 as indicated by the reflected ray 122. The reflected ray 122 is further reflected by the top reflector and falls on the surrounding area as shown by 124. Similarly an incident ray 126 emitted from an LED located in the bottom reflector 110 is reflected by the top reflector 112 and is reflected by the bottom reflector once again as shown by ray 128. The ray 128 is reflected once again by the top reflector 110 and falls in the surrounding area providing intense diffused light as indicated by ray 130.

The advantage of this invention is that the loss of light resulting from diffusing the light is minimized therefore the intensity of the light is strong making it extremely useful as a light source. Also, the design prevents the light from the LED falling directly in the user's eye and thus preventing injury.

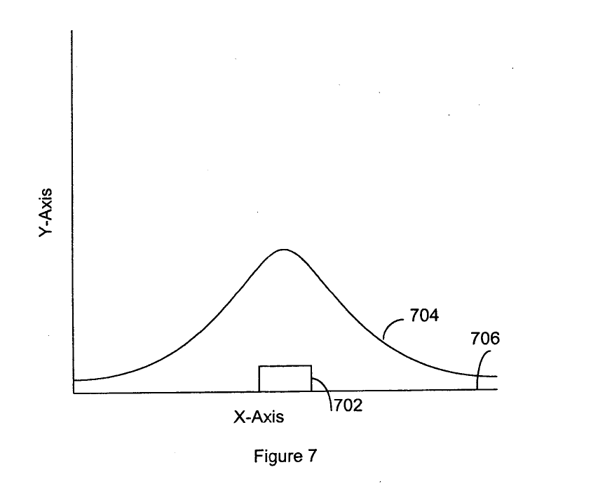

The intensity of the light near the lighting device 100 is concentrated and therefore, it is extremely useful as a table lamp. A graph illustrating the intensity distribution verses distance is shown in FIG. 7. The lighting device is shown as 702, distance is shown on the x-axis and the light intensity on the y-axis. The graph 704 shows that the light intensity peaks near the lighting device 702. There is a sharp decrease in intensity beyond a certain distance.

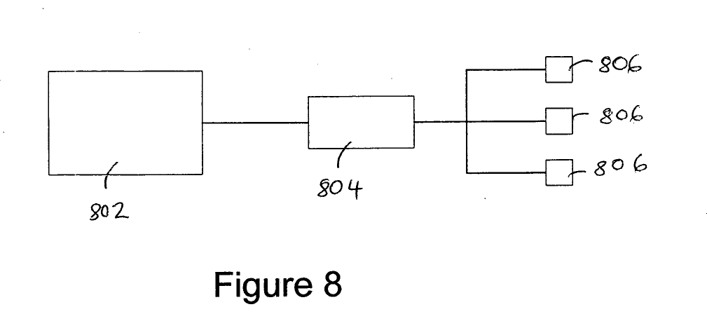

In remote areas or incase of emergency a lighting system that has several lighting devices to provide light to various locations such as different rooms of a house would be extremely useful. A lighting system with several lighting devices is illustrated in FIG. 8. FIG. 8 is a lighting system 800 is shown in block diagrams. The lighting system 800 includes a solar power source 802. The solar power source is connected to a plurality of lighting devices 806 via a controller 804. The lighting devices include a re-chargeable voltage source (not shown). The voltage source is re-charged by the energy supplied from the solar power source (not shown). The lighting devices 806 further include LEDs as light sources (not shown). The energy for the light sources is provided by the voltage source.

In a preferred embodiment each of the lighting device is provided with a switch (not shown) so that the power to the LEDs may be controlled and thus the light source may switched on only when needed thus conserving energy. Also here one controller is attached to all the lighting devices 806, however one skilled in the art would appreciate that each device may be provided with a controller if desired. The controller performs several functions in the lighting system 800. The controller may be used to control the charging of the voltage source. It may also be used to maintain current and voltage for charging voltage sources. Still yet, the controller 804 may be used to maintain a constant current to the LEDs. In a preferred embodiment the lighting device includes reflectors (not shown) so that the light from the LEDs are diffused without any losses. As can be seen the lighting system may be used as a backup in a house. The solar power source may be solar panel that may be placed on top of a building. Each of the lighting devices 806 could be placed at different locations in the building so that the building could be lit with the system.

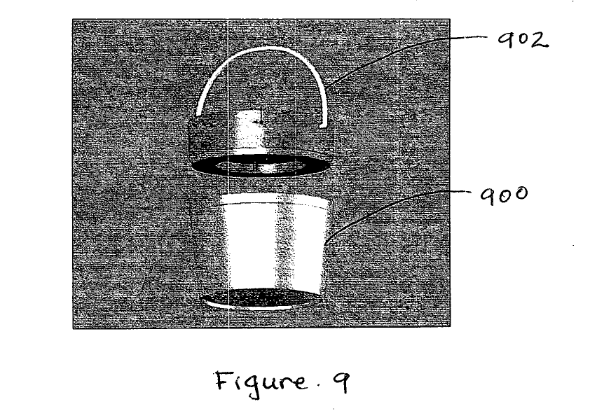

Portable lighting devices such as flash lights are generally dependent on batteries. As flash lights are used occasionally, it is often the case that the batteries are dead when the need arises. A portable lighting device that may be re-charged with solar power is described in FIG. 9. The portable light 900 includes plurality of LEDs as light source (not shown). The energy for the light source comes from a re-chargeable voltage source (not shown). The re-chargeable voltage source is in communication with a solar power source (not shown). In a preferred embodiment the solar power source may be a solar panel and the re-chargeable power source is a battery pack. The light from the LEDs are reflected using reflectors (not shown) to provide non-directional diffused portable light.

Foregoing described embodiments of the invention are provided as illustrations and descriptions. They are not intended to limit the invention to precise form described. In particular, it is contemplated that functional implementation of invention described herein may be implemented equivalently in hardware, software, firmware, and/or other available functional components or building blocks.

Other variations and embodiments are possible in light of above teachings, and it is thus intended that the scope of invention not be limited by this Detailed Description, but rather by claims following.

1. A lighting device comprising:
a plurality of LEDs as a light source;
a solar power source;
a rechargeable voltage source in communication with the solar power source; and
a light reflector for reflecting the light emerging from the LEDs.

2. The device of claim 1 wherein the light source is bright white LEDs.

3. The device of claim 2 wherein the light reflector comprising a reflective layer.

4. The device of claim 3 wherein the rechargeable voltage source is a battery pack.

5. The device of claim 4 wherein the light device further comprising a charge controller.

6. The device of claim 5, wherein the charge controller controls overcharging of the battery pack.

7. The device of claim 6, wherein the charge controller controls undercharging of the battery pack.

8. The device of claim 7, wherein the charge controller controls the amount of charge that is supplied to the LEDs.

9. A lighting system having a plurality of lighting devices, wherein each of the lighting devices comprising:
a plurality of LEDs as a light source;
a solar power source;
a rechargeable voltage source in communication with the solar power source; and
a light reflector for reflecting the light emerging from the LEDs.

10. The device of claim 9 wherein the light source is bright white LEDs.

11. The device of claim 10 wherein the light reflector comprising a reflective layer.

12. The device of claim 11 wherein the rechargeable voltage source is a battery pack.

13. The device of claim 12 wherein the light device further comprising a charge controller.

14. The device of claim 13, wherein the charge controller controls overcharging of the battery pack.

15. The device of claim 14, wherein the charge controller controls undercharging of the battery pack.

16. The device of claim 15, wherein the charge controller controls the amount of charge that is supplied to the LEDs.

17. A portable lighting device comprising:
a plurality of LEDs as light source;
a solar power source;
a rechargeable voltage source in communication with the solar power source; and
a light reflector for reflecting light emerging from the LEDs.

18. A portable lighting device as claimed in claim 17, wherein the lighting device includes a handle;
